(19) United States
(12) Patent Application Publication
(10) Pub. No.: US 2007/0205607 A1
(43) Pub. Date: Sep. 6, 2007

(54) Panic Door Opening Device

(75) Inventor: Egbert Becker, Bad Salzuflen (DE)

Correspondence Address: COHEN, PONTANI, LIEBERMAN & PAVANE, 551 FIFTH AVENUE, SUITE 1210, NEW YORK, NY, 10176, US

(73) Assignee: Dorma GmbH + Co. KG, Ennepetal (DE)

(21) Appl. No.: 10/592,072

(22) PCT Filed: Mar. 8, 2005
(86) PCT No.: PCT/EP05/02404

§ 371 Date: Sep. 7, 2006

(30) Foreign Application Priority Data
Mar. 11, 2004 (DE) 10 2004 012 323.3

(51) Int. Cl. E05B 65/10

(52) U.S. Cl. 292/92

(57) ABSTRACT

An anti-panic door opening device for actuating a door lock on a door. The device includes a handle bar having a length and two ends; two universal supports mountable on the door, each universal support having a bracket and a lock cover portion for receiving a portion of a door lock mounted in the door; and two articulated extensions. The articulated extensions are attached to the ends of the handle bar and are pivotally attached the respective brackets so that the handle bar and the articulated extensions are pivotally supported over a width of the door.

The invention relates to an anti-panic door opening device according to the features of the generic part of the independent claim.

More particularly, the invention relates to an anti-panic door opening device including a handle bar, which is supported pivotally over the width of a door, the bearing being realized in an upper region of a plate of a door lock.

Devices for opening anti-panic doors are already known from the state of the art in many different embodiments. Examples are shown in DE 82 33 920 U1, in DE 79 36 680 U1 or in DE 32 13 668 A1.

With anti-panic door opening devices, a handle bar is supported on the inside of the door such that upon pushing the handle bar, the latter automatically unlocks the door, such that, in the event of an emergency, the user can open the door without any problem and leave the room.

The solutions known from the state of the art are disadvantageous in that the devices are either designed as a separate unit and thus can only be completely mounted together with the locks and the other equipment items, or they may require extensive remodelling measures, in order to retrofit existing doors.

The object of the invention is to create an anti-panic door opening device of the type mentioned above, which, while having a simple structure and being inexpensively to manufacture, is universally usable and can be combined in particular with many different door locks and doors.

According to the invention, the problem is solved with the features of the independent claim, the dependent claims representing further advantageous embodiments of the invention.

According to the invention, it is thus intended that the device comprises a universal support at which a bracket for bearing an articulated area of a handle bar is formed. Thus, by attaching the universal support at the door, the inventive device can be simply and operationally reliable mounted and installed. In order to provide adaptation to different door locks, in particular to different distances between the central axis of the door handle and the central axis of the lock, the universal support according to the invention presents corresponding structural details designed to match different dimensions of many different door locks to be used.

Furthermore, it is intended that the inventive universal support can be combined with variously designed covers.

Thus, according to the invention, a modular construction system is created, allowing for mounting an anti-panic door opening device with many different door locks having many different dimensions, while using a single universal support.

It is particularly advantageous, if the universal support is formed as a sheet-metal stamping part. As the universal support can be covered by at least one cover and can be faced visually, there is no need for the support itself to meet high visual requirements. Thereby manufacturing costs are considerably reduced.

Preferably, the universal support is provided with several connection openings for different door locks and/or different locks (cylinder locks). Thus, it is possible to satisfy all likely application cases with a single universal support. In this case, it is moreover advantageous that the universal support can be additionally equipped with a plurality of mounting openings for screws or the like to allow for adaptation to the respective lock constructions.

It is particularly advantageous, if a cover is provided for the bracket. This cover can be used for many different embodiments and embodiment designs while a preferably provided second cover is formed in the shape of a plate (door lock plate). This other cover in the shape of a plate can be formed as a long plate or as a short plate; however, it can be manufactured likewise as a blind plate (without any opening for a lock).

As the two covers do not have to assume any supporting functions and thus merely serve as cover and facing, they can be produced in a simple and inexpensive manner, for example as a plastic molded part or as a die cast part. In this case, it is very easy to take into consideration the respective surface design or color variation.

The inventive anti-panic door opening device can thus be provided in an exceptional simple manner as a modular construction system, particularly as the handle bar as well and the articulated area thereof can be adapted to the most various visual requirements. Furthermore, it is possible to dimension both the handle bar and the articulated areas differently according to the modular construction principle, for example with regard to the diameter, to the section, to the curvature radius (particularly in the articulated area), etc.

Thus, according to the invention, a device is created, which, at cost-effective producibility, presents a maximum of operational safety and is universally usable.

In the following, the invention will be described on the basis of one embodiment example in conjunction with the drawings, in which:

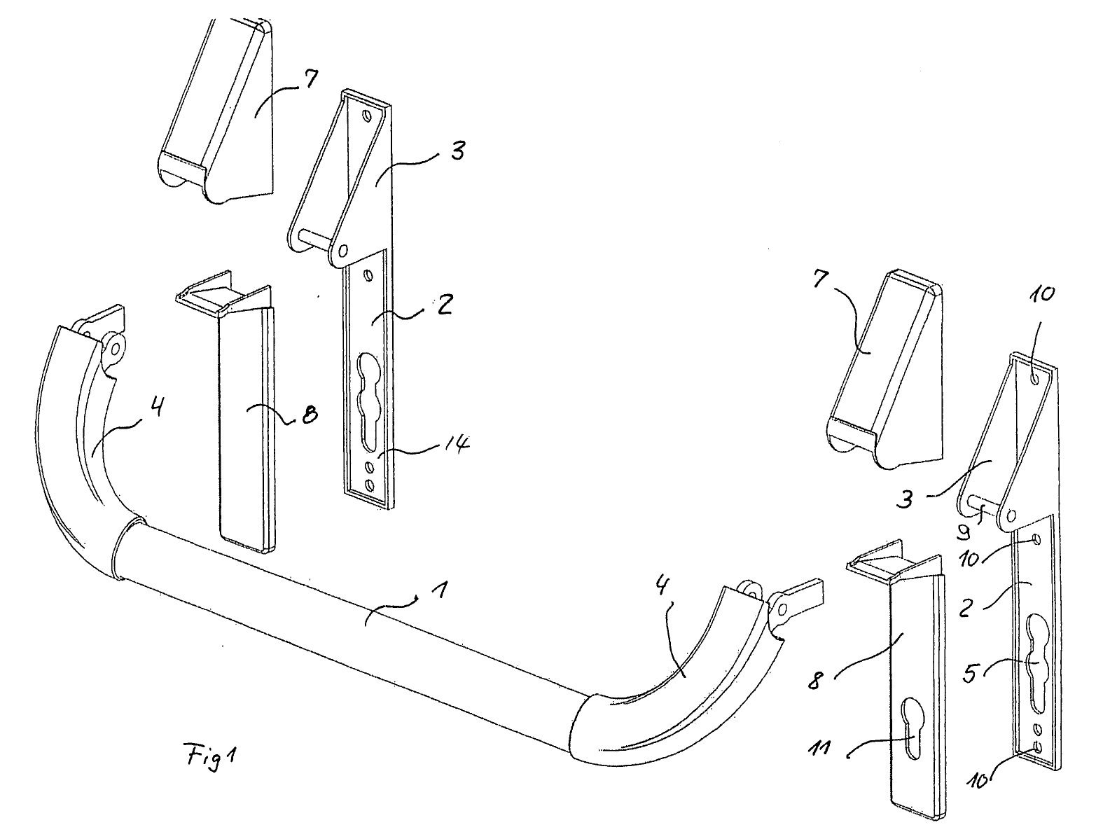

FIG. 1 shows a perspective exploded view of an embodiment example of the inventive anti-panic door opening device,

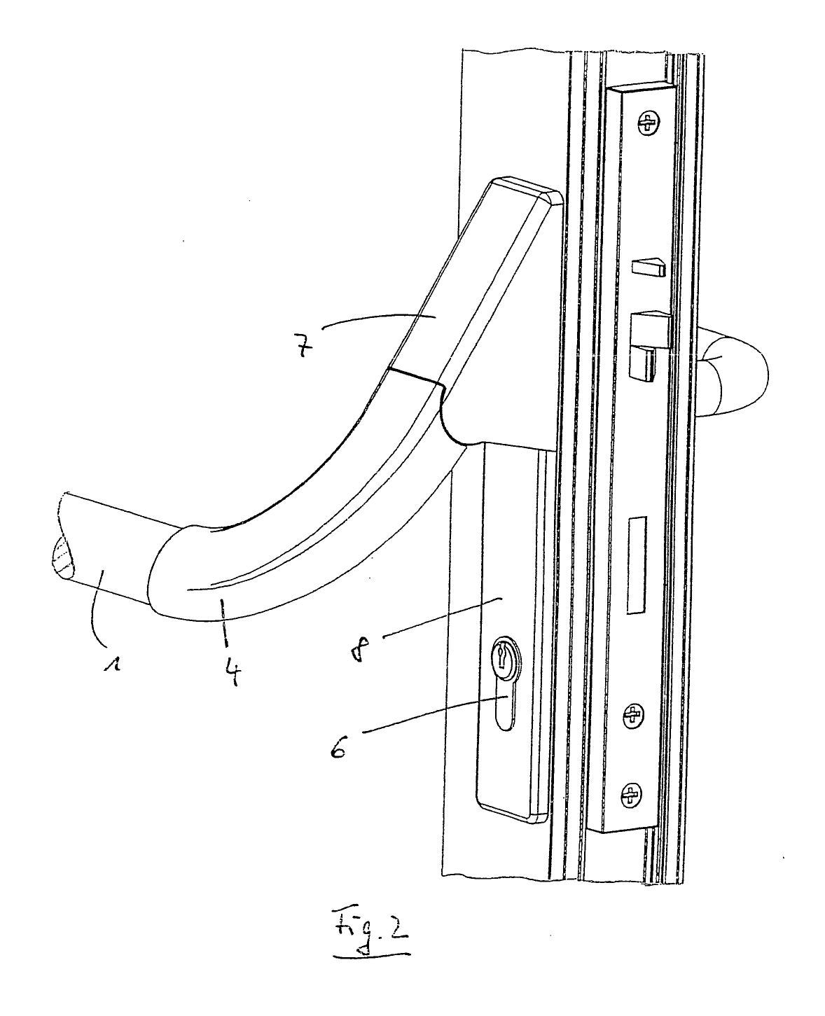

FIG. 2 shows a perspective partial view of a completely mounted inventive anti-panic door opening device, and

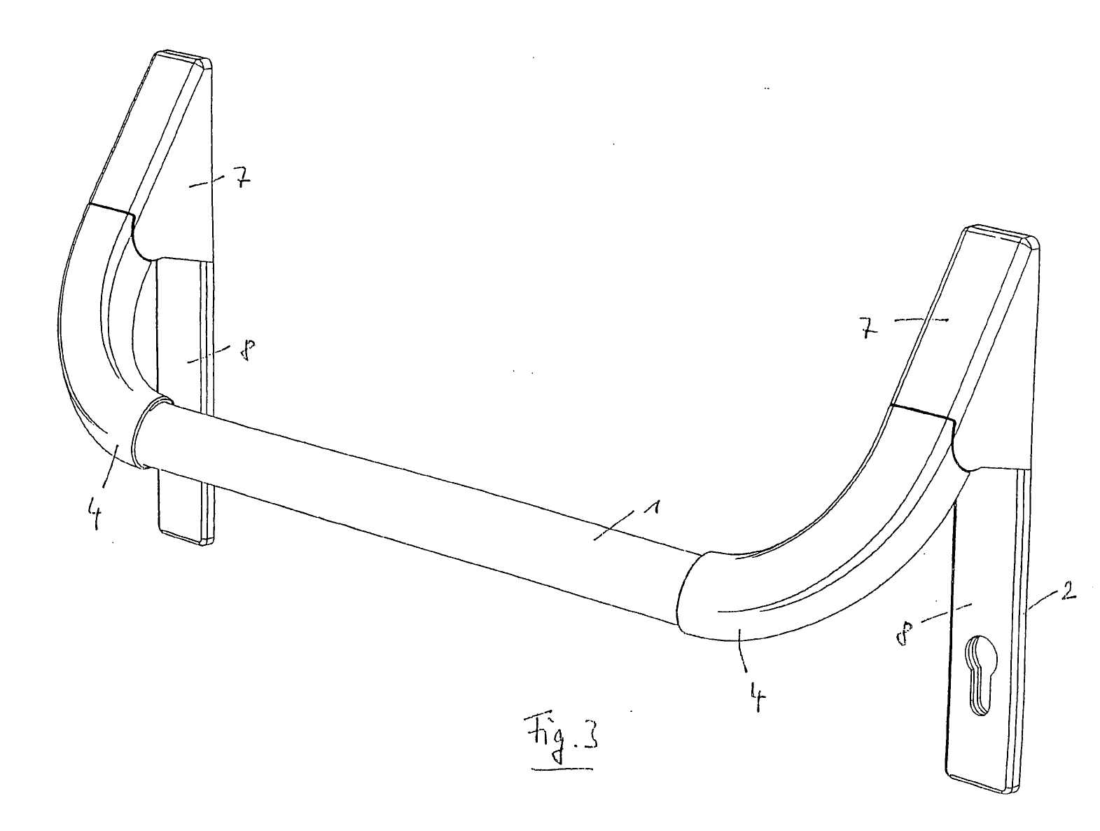

FIG. 3 shows a perspective overall view in the mounted condition.

The inventive device comprises a tube-like handle bar 1, respectively one arch-like articulated area 4 being attached at both end areas thereof. The attachment can be realized by simply fitting the articulated areas, which have a reception, on the handle bar.

The handle bar 1 is easily adaptable to the width of the door by shortening or lengthening.

Furthermore, the invention comprises a universal support 2 at which a bracket 3 is formed. Preferably, the universal support 2 is formed together with the bracket 3 as a sheet-metal bending part or as a sheet-metal stamping part or as an injection-molded part. It comprises several connection openings 5 for locks 6 (not illustrated in FIG. 1) of variously located closing cylinders. Furthermore, several mounting openings 10 are provided for screwing the universal support 2 to the door and/or to the door lock.

Moreover, the bracket 3 supports a pivot axle 9 for the articulated area 4. As the actuating mechanism is well known, a detailed description thereof has been omitted.

According to the invention, a cover 7 which can be snapped on the bracket 3 respectively on the universal support 2 or can be mounted in another way is provided for the bracket 3. The cover 7 may have different shapes to be adaptable to an ambient design; however, the attachment type will be always the same.

Furthermore, the invention comprises a cover 8 in the shape of a plate having an opening 11 for the lock 6 (see FIG. 2). This cover 8 likewise can be snapped on, fitted on or can be attached in another way. A cover 8 without such opening 11 is provided for the side opposite the lock 6 of the anti-panic door opening device (see left part of FIG. 1). The cover 7 and the cover 8 each are separately attachable at the universal support 2.

FIG. 2 shows a view in a partial sectional view in the mounted condition from which the allocation of the individual construction components is clearly visible. Furthermore, an SVP-lock (self-locking anti-panic door lock) is illustrated within a profile frame. FIG. 3 shows a perspective overall view of the anti-panic door opening device in the mounted condition, similar to the illustration of FIG. 1.

### REFERENCES

1 handle bar
2 universal support
3 bracket
4 articulated area
5 connection opening
6 lock
7 cover
8 cover/plate
9 pivot axle
10 mounting opening
11 opening

1.-10. (canceled)

11. An anti-panic door opening device for actuating a door lock on a door, comprising:
a handle bar having a length and two ends;
two universal supports mountable on a door, each universal support having a bracket and a lock cover portion sized to cover a portion of a door lock mounted in the door; and
two articulated extensions, each articulated extension being attachable to one end of the handle bar, and each articulated extension being pivotally attachable to one of the brackets.

12. The anti-panic door opening device of claim 11, wherein each universal support is made by stamping or die casting.

13. The anti-panic door opening device of claim 11, wherein each universal support has a connection opening sized to receive at least a portion of a door lock cylinder.

14. The anti-panic door opening device of claim 11, further comprising a cover for covering each of the brackets.

15. The anti-panic door opening device of claim 11, further comprising two plate-shaped covers each sized to cover one of the lock cover portions.

16. The anti-panic door opening device of claim 15, wherein each cover is comprised of a metal plate.

17. The anti-panic door opening device of claim 11, constituting a modular system.
